(19) United States
(12) Patent Application Publication
(10) Pub. No.: US 2026/0055962 A1
(43) Pub. Date: Feb. 26, 2026

(54) DRYING DEVICE INCLUDING MECHANISM TO DISCONNECT POWER TO HEATING DEVICE, AND IMAGE FORMING SYSTEM

(71) Applicant: KYOCERA Document Solutions Inc., Osaka (JP)

(72) Inventor: Hisaji KAWAI, Osaka (JP)

(73) Assignee: KYOCERA Document Solutions Inc., Osaka (JP)

(21) Appl. No.: 19/304,520

(22) Filed: Aug. 19, 2025

(30) Foreign Application Priority Data
Aug. 20, 2024 (JP) 2024-139329
Aug. 4, 2025 (JP) 2025-130364

(51) Int. Cl. F26B 25/00; B41J 11/00; B41J 29/13

(52) U.S. Cl. CPC F26B 25/009; B41J 11/00242; B41J 29/13

(57) ABSTRACT

A drying device includes a casing, a lock mechanism, a heating device, a controller, a detection device, and a disconnection mechanism. The casing includes a cover that can be opened and closed. The lock mechanism restricts the cover from being opened. The heating device is provided inside the casing, and raises a temperature when power is supplied. The controller controls power supply to the heating device, and an action of the lock mechanism. The detection device detects an unlocking action of the lock mechanism. The disconnection mechanism disconnects the power supply to the heating device, when the detection device detects the unlocking action.

### INCORPORATION BY REFERENCE

This application claims priority to Japanese Patent Application No. 2024-139329 filed on Aug. 20, 2024, and Japanese Patent Application No. 2025-130364 filed on Aug. 4, 2025, the entire contents of which are incorporated by reference herein.

### BACKGROUND

The present disclosure relates to a drying device and an image forming system, and in particular to a technique to disconnect power to a heating device.

Regarding an apparatus incorporated with a heating device inside the casing, a technique is known that prevents a user from contacting the heating device of a high temperature, to secure safety for the user.

An example of such technique includes acquiring the temperature of a desiccation unit inside the casing, from a temperature sensor, restricting a cover provided on the casing from being opened, when the acquired temperature is higher than a predetermined threshold, and allowing the cover to be opened when the acquired temperature is equal to or lower than the predetermined threshold.

Another example of the technique includes acquiring an internal temperature of the casing, having the heating device therein, from a temperature detector, locking the outer cover thereby restricting the outer cover from being opened, when the internal temperature is higher than a predetermined temperature, and unlocking the outer cover thereby allowing the outer cover to be opened, when the internal temperature is equal to or lower than the predetermined temperature.

### SUMMARY

The disclosure proposes further improvement of the foregoing technique.

In an aspect, the disclosure provides a drying device including a casing, a lock mechanism, a heating device, a controller, a detection device, and a disconnection mechanism. The casing includes a cover that can be opened and closed. The lock mechanism restricts the cover from being opened. The heating device is provided inside the casing, and raises a temperature when power is supplied. The controller controls power supply to the heating device, and an action of the lock mechanism. The detection device detects an unlocking action of the lock mechanism. The disconnection mechanism disconnects the power supply to the heating device, when the detection device detects the unlocking action.

In another aspect, the disclosure provides an image forming system including an image forming apparatus that forms an image on a sheet by ejecting ink thereon, and the foregoing drying device.

### BRIEF DESCRIPTION OF THE DRAWINGS

FIG. 1 is a schematic front cross-sectional view showing a configuration of an image forming system;

FIG. 2 is a block diagram showing an internal configuration of an image forming apparatus and a drying device;

FIG. 3 is a schematic drawing for explaining a configuration of a casing;

FIG. 4 is a schematic drawing showing a lock mechanism in an unlocked state;

FIG. 5 is a schematic drawing showing the lock mechanism locking a cover;

FIG. 6 is a schematic drawing for explaining a configuration of a detection device;

FIG. 7 is a schematic front view showing a part of a drying mechanism;

FIG. 8 is a circuit diagram of a heater circuit and a protection circuit;

FIG. 9 is a flowchart showing a lock control process;

FIG. 10 is a flowchart showing a sheet jam fixing process; and

FIG. 11 is a schematic front view showing a heating device in an elevated state.

### DETAILED DESCRIPTION

Hereafter, a drying device and an image forming system according to an embodiment will be described, with reference to the drawings.

### [Configuration of Image Forming System 1]

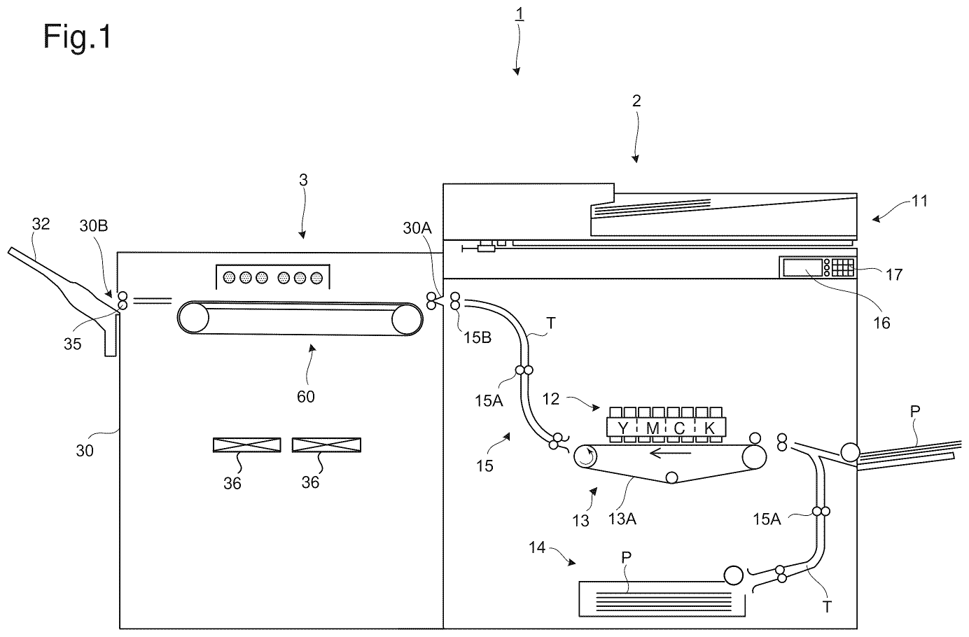

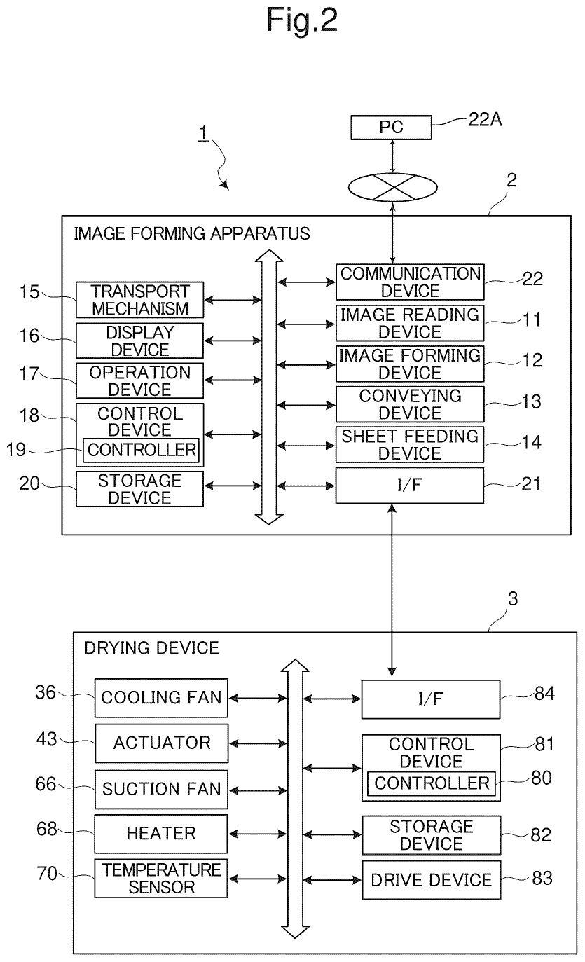

The image forming system 1 and the drying device 3 according to the embodiment of the disclosure will be described with reference to the drawings. As shown in FIG. 1 and FIG. 2, the image forming system 1 includes an image forming apparatus 2 and the drying device 3. The image forming apparatus 2 ejects ink onto a sheet P, thereby forming an image thereon. The drying device 3 heats the ink ejected onto the sheet P, thereby drying the ink.

Hereinafter, the up-down direction will be defined on the basis of a normal installation state, as shown in FIG. 1. The front-rear direction will be defined on the basis of the position of a user operating the system, in the normal installation state. The direction orthogonal to the up-down direction and the front-rear direction will be defined as left-right direction, and the left side and the right side will be defined on the basis of the direction in which the user is oriented, when operating the system.

### [Configuration of Image Forming Apparatus 2]

As shown in FIG. 1, the image forming apparatus 2 is an ink jet recording apparatus. The image forming apparatus 2 includes an image reading device 11, an image forming device 12, a conveying device 13, a sheet feeding device 14, a transport mechanism 15, a display device 16, and an operation device 17.

The image reading device 11 reads the image of a document, either by a moving document reading method or a fixed document reading method, and generates image data. The image forming device 12 ejects ink droplets onto the sheet P being carried by the conveying device 13, from lineheads respectively corresponding to four colors, namely yellow, magenta, cyan, and black, thereby forming a color image on the sheet P. Here, the sheet P is not limited to paper media, but may be, for example, an overhead projector (OHP) sheet.

The conveying device 13 carries the sheet P delivered from the sheet feeding device 14, by adsorbing the sheet P to a conveying belt 13A. The sheet feeding device 14 draws out, with a pickup roller, the sheets P stored in sheet cassettes, or placed on a manual bypass tray, and delivers the sheet P to a transport route T.

The transport mechanism 15 includes a plurality of transport roller pairs 15A, a delivery roller pair 15B, and a transport motor. The transport mechanism 15 drives the transport motor so as to rotate the transport roller pair 15A and the delivery roller pair 15B, thereby transporting the sheet P along the transport route T, toward the drying device 3.

The display device 16 is, for example, constituted of an LCD or an organic light-emitting diode (OLED) display. The display device 16 displays various types of screens.

The operation device 17 includes a plurality of hard keys such as a start key. The operation device 17 also includes a touch panel overlaid on the display device 16. The operation device 17 receives an instruction inputted by a user.

As shown in FIG. 2, the image forming apparatus 2 further includes a control device 18, a storage device 20, an interface (I/F) 21, and a communication device 22. The control device 18 includes a processor, a random-access memory (RAM), and a read-only memory (ROM).

The processor is, for example, a central processing unit (CPU), a micro processing unit (MPU), or an application-specific integrated circuit (ASIC).

The control device 18 acts as a controller 19, when the processor executes a control program stored in the ROM or the storage device 20. The controller 19 controls the operation of the components of the image forming apparatus 2. Here, the controller 19 may be constituted in the form of a logic circuit, instead of being realized by the operation based on the control program, or realized by a plurality of control devices.

The control device 18 is electrically connected to the image reading device 11, the image forming device 12, the conveying device 13, the sheet feeding device 14, the transport mechanism 15, the display device 16, the operation device 17, the storage device 20, the I/F 21, and the communication device 22.

The storage device 20 is a large-capacity memory unit such as a solid state drive (SSD), or a hard disk drive (HDD). The storage device 20 stores therein various control programs for realizing the basic functions of the image forming apparatus 2, in addition to various types of data.

To the I/F 21, the drying device 3 is connected. The I/F 21 includes a terminal for making electrical connection with the drying device 3.

The communication device 22 includes a communication module such as a local area network (LAN) board. The controller 19 performs data communication through the communication device 22, with an external device such as a personal computer (PC) 22A connected via a network.

A power source is connected to each of the components of the image forming apparatus 2, so that those components are activated when power is supplied from the power source.

### [Configuration of Drying Device 3]

### Casing 30

As shown in FIG. 1, the drying device 3 includes a casing 30. The casing 30 includes an inlet port 30A formed on the side face on the side of the image forming apparatus 2 (i.e., right side face), and a delivery port 30B formed on the left side face. An output tray 31 is provided on the lower side of the delivery port 30B on the left side face of the casing 30. A delivery roller pair 32, for delivering the sheet P to the output tray 31, is provided in the proximity of the delivery port 30B.

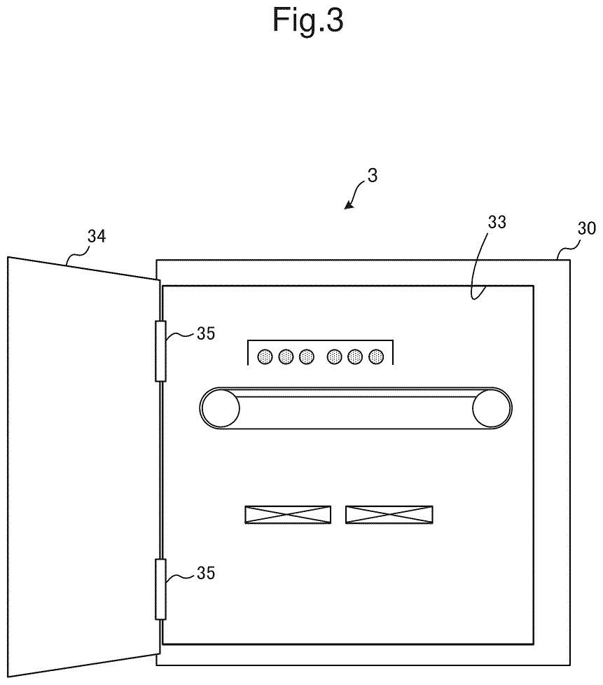

As shown in FIG. 3, the casing 30 has an opening 33, formed on the front face. The casing 30 also includes a cover 34, for covering the opening 33. The cover 34 has a plate shape, and is mounted on the casing 30 via hinges 35, fixed to the casing 30 at positions in the proximity of the left end of the opening 33. The cover 34 is configured to open or close the opening 33, by being made to pivot about the hinges 35.

### Lock Mechanism 40

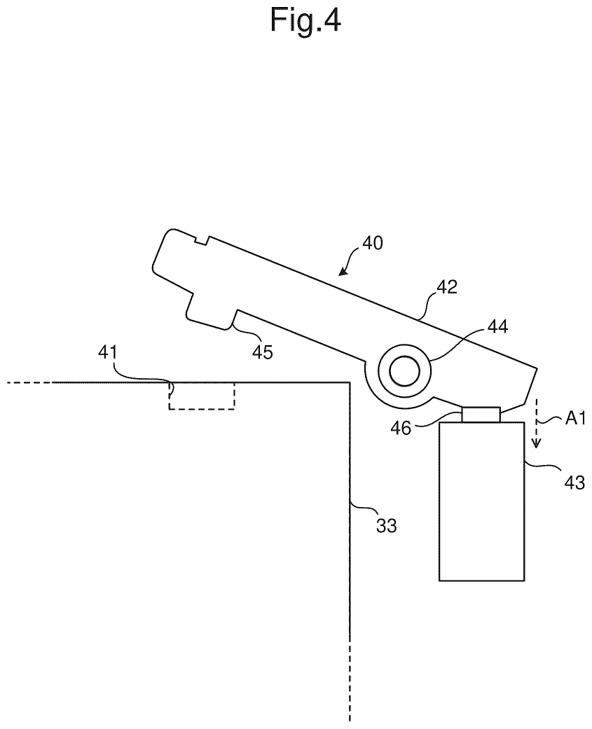

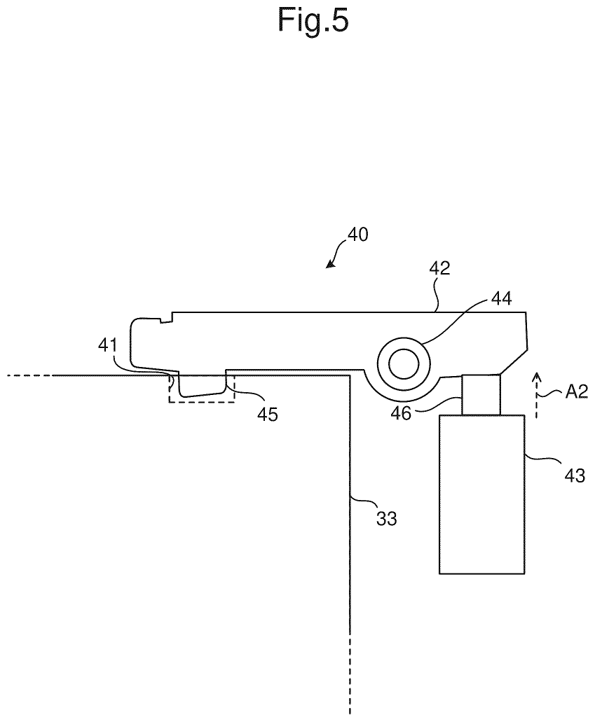

As shown in FIG. 4 and FIG. 5, the drying device 3 includes a lock mechanism 40, configured to restrict the cover 34 from being opened. The lock mechanism 40 includes a cutaway portion 41, a lever 42, and an actuator 43. The cutaway portion 41 is formed on the upper end face of the cover 34, at a position in the proximity of the right upper corner. The lever 42 and the actuator 43 are located inside the casing 30.

The lever 42 is a bar-shaped piece, and configured to pivot about a rotary shaft 44, located at a generally central position of the lever 42 in the longitudinal direction. The lever 42 located on the front end portion of the rotary shaft 44. The rotary shaft 44 is located in the proximity of the right upper corner of the cover 34, so as to extend in the front-rear direction. The lever 42 includes a protrusion 45, formed at the left end portion so as to protrude toward the cutaway portion 41.

The actuator 43 serves as a drive device operated by a solenoid. The actuator 43 includes a moving element 46 movable in the up-down direction. The moving element 46 is connected to the right end portion of the lever 42. When the controller 80 shown in FIG. 2 supplies the power to the actuator 43, the moving element 46 is retracted downward (direction of arrow A1 in FIG. 4). Accordingly, the lever 42 is made to pivot about the rotary shaft 44, such that the protrusion 45 moves away from the cutaway portion 41, thereby realizing an unlocked state, where the protrusion 45 is disengaged from the cutaway portion 41, as shown in FIG. 4.

On the other hand, when the controller 80 disconnects the power supply to the actuator 43, the moving element 46 is lifted upward (direction of arrow A2 in FIG. 5). Accordingly, the lever 42 is made to pivot about the rotary shaft 44, such that the protrusion 45 moves toward the cutaway portion 41, thereby realizing a locked state, where the protrusion 45 is fitted in the cutaway portion 41, as shown in FIG. 5. In other words, the moving element 46 changes the position to lock or unlock the cover 34.

### Detection Device 50

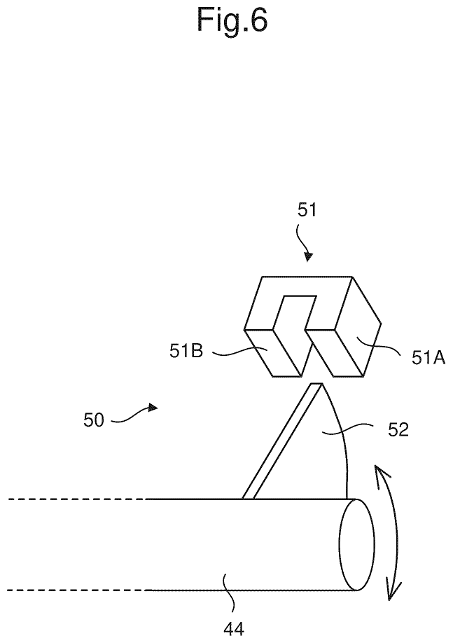

Referring to FIG. 6, the drying device 3 includes a detection device 50 that detects the unlocking action of the lock mechanism 40. The detection device 50 includes a photo interrupter (PI) sensor 51, and a shielding plate 52. The PI sensor 51 includes a light emitting element 51A and a photodetector 51B opposed to each other, to allow the shielding plate 52 to pass therebetween. The shielding plate 52 is, for example, a fan-shaped plate located at the rear end portion in the longitudinal direction, of the rotary shaft 44 that rotates interlocked with the lever 42.

The detection device 50 outputs an ON signal when detecting the presence of the shielding plate 52 (in this embodiment, when the cover 34 is locked), and outputs an OFF signal when the shielding plate 52 is not detected (in this embodiment, when the cover 34 is unlocked).

The detection device 50 indirectly detects the position of the moving element 46, by detecting the rotational movement of the rotary shaft 44 as above, thereby detecting the unlocking action. Here, the detection device 50 is not limited to the PI sensor provided that the position of the moving element 46 can be detected. For example, a mechanical sensor that mechanically detects the contact with the moving element 46 may be employed.

### Drying Mechanism 60

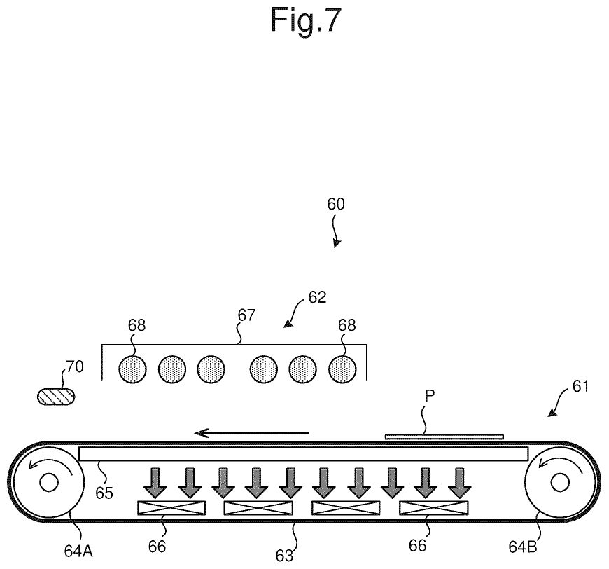

As shown in FIG. 1 and FIG. 7, the drying device 3 includes a drying mechanism 60 and a temperature sensor 70, provided inside the casing 30. The drying mechanism 60 includes a conveying device 61 and a heating device 62. The conveying device 61 transports the sheet P. The heating device 62 heats the sheet P being transported by the conveying device 61.

To be more specific, the conveying device 61 includes a conveying belt 63, a drive roller 64A and a follower roller 64B, a support plate 65, and a plurality of suction fans 66. The conveying belt 63 is an endless belt stretched around the drive roller 64A and the follower roller 64B. The drive roller 64A is driven by a first drive motor of the drive device 83 shown in FIG. 2, so as to rotate counterclockwise in FIG. 7.

The conveying belt 63 is made to revolve counterclockwise in FIG. 7, by the rotation of the drive roller 64A. The follower roller 64B also rotates counterclockwise in FIG. 7, so as to follow the revolution of the conveying belt 63. The conveying belt 63 transports the sheet P, delivered from the image forming apparatus 2 through the inlet port 30A, toward the delivery port 30B. The sheet P transported toward the delivery port 30B is delivered to the output tray 31 by the delivery roller pair 32, through the delivery port 30B.

The support plate 65 is located inside the conveying belt 63, with the upper face set in contact with the inner circumferential surface of the conveying belt 63. The length of the support plate 65 in the sheet width direction is generally the same as the length of the conveying belt 63 in the sheet width direction. Here, the sheet width direction refers to the direction orthogonal to the transport direction of the sheet P. The conveying belt 63 and the support plate 65 each include a multitude of air holes.

The plurality of suction fans 66 are located inside the conveying belt 63. When the plurality of suction fans 66 are driven by the controller 80, the sheet P on the conveying belt 63 is sucked through the multitude of air holes. Accordingly, the sheet P is adsorbed to the conveying belt 63, while being transported.

The heating device 62 includes a housing 67 and a plurality of heaters 68. The housing 67 is located on the upper side of the conveying belt 63. The housing 67 has a box shape, the bottom face of which is open. The housing 67 is made to move in the up-down direction, by an elevation mechanism connected to a second drive motor of the drive device 83.

The plurality of heaters 68 constitute the heating device that raises the temperature when power is supplied. The plurality of heaters 68 may be, for example, halogen heaters, carbon heaters, or infrared heaters, formed in a bar shape or belt shape. The plurality of heaters 68 are fixed inside the housing 67, and aligned with a spacing between each other in the sheet transport direction, such that the longitudinal direction extends parallel to the sheet width direction.

The plurality of heaters 68 heat the sheet P on the conveying belt 63, from the upper side of the conveying belt 63. When the sheet Pis heated by the heaters 68, the ink on the sheet P evaporates, and the pigment in the ink is fixed onto the sheet P.

### Temperature Sensor 70

As shown in FIG. 7, the temperature sensor 70 is located in the proximity of the drying mechanism 60. The temperature sensor 70 detects the temperature of the region in the proximity of the drying mechanism 60, and outputs the detection result to the control device 81 shown in FIG. 2.

### Cooling Mechanism

Referring again to FIG. 1, the drying device 3 includes cooling fans 36 located inside the casing 30. The cooling fans 36 are located on the lower side of the drying mechanism 60, and blows air toward the drying mechanism 60 from the lower side, thereby cooling the drying mechanism 60. Here, the drying device 3 may also include an exhaust mechanism for discharging the air inside the casing 30 to outside.

Referring again to FIG. 2, the drying device 3 includes a control device 81, a storage device 82, a drive device 83, and an I/F 84. The control device 81 includes a processor, a RAM, and a ROM. The processor is, for example, a CPU, an MPU, or an ASIC.

The control device 81 acts as a controller 80, when the processor executes a control program stored in the ROM or the storage device 82. The controller 80 controls the operation of the components of the drying device 3. For example, the controller 80 controls the power supply to the heaters 68, and the operation of the lock mechanism 40.

Here, the controller 80 may be constituted in the form of a logic circuit, instead of being realized by the operation based on the control program, or realized by a plurality of control devices.

The control device 81 is electrically connected to the cooling fan 36, the actuator 43, the suction fan 66, the heater 68, the temperature sensor 70, the storage device 82, the drive device 83, and the I/F 84.

The storage device 82 is a large-capacity memory unit such as an SSD, or an HDD. The storage device 82 stores therein various control programs for realizing the basic functions of the drying device 3, in addition to various types of data.

The drive device 83 includes a plurality of drive motors. The drive device 83 drives each of the drive motors, to thereby rotate the drive roller 64A, move the housing 67 up or downward, and rotate the delivery roller pair 32.

To the I/F 84, the image forming apparatus 2 is connected. The I/F 84 includes a terminal for making electrical connection with the image forming apparatus 2.

A power source is connected to each of the components of the drying device 3, so that those components are activated when power is supplied from the power source.

### Heater Circuit 90

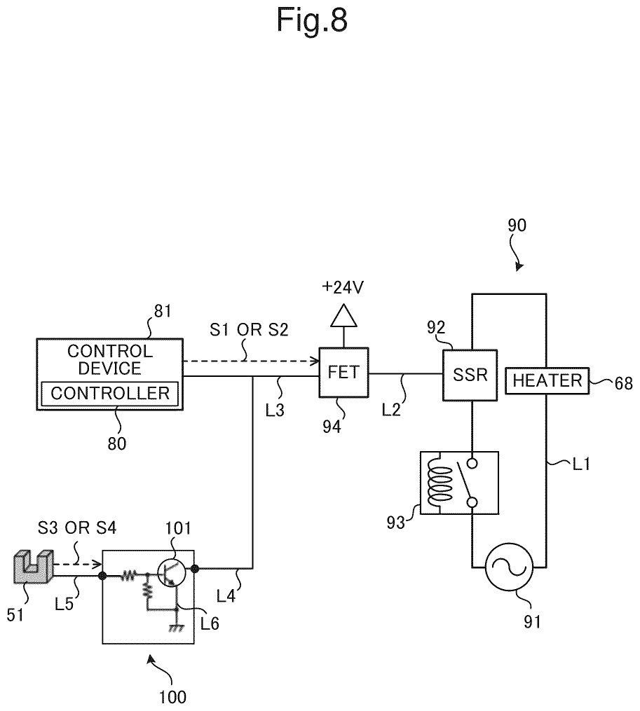

As shown in FIG. 8, the drying device 3 includes a heater circuit 90, to be used by the controller 80 to control the power supply to the heaters 68. The heater circuit 90 includes a power supply line L1, for supplying the power from the commercial power source 91 to the heaters 68. The power supply line L1 connects the commercial power source 91, the heaters 68, a solid state relay (SSR) 92, and a relay circuit 93 in series, in this order.

The SSR 92 is connected to a field effect transistor (FET) 94, via a signal line L2. The FET 94 switches the SSR 92 and the relay circuit 93, thereby turning on and off the power supply through the power supply line L1. The control device 81 is connected to the FET 94, via a signal line L3. The controller 80 controls the power supply to the heaters 68, via the signal line L3.

To be more specific, when the controller 80 outputs a High signal S1 to the FET 94 via the signal line L3, the FET 94 turns on the SSR 92 and the relay circuit 93. Accordingly, the current runs through the power supply line L1, and the heaters 68 are activated.

When the controller 80 outputs a Low signal S1 to the FET 94 via the signal line L3, the FET 94 turns off the SSR 92 and the relay circuit 93. Accordingly, the conduction through the power supply line L1 is disconnected, and the heaters 68 are turned off.

### Protection Circuit 100

In this embodiment, the drying device 3 includes a protection circuit 100, acting as the disconnection mechanism that disconnects the power supply to the heaters 68, when the detection device 50 detects the unlocking action. The protection circuit 100 includes an NPN-type bipolar transistor 101, connected to the signal line L3 via a signal line L4.

The bipolar transistor 101 is connected to the PI sensor 51 via a signal line L5. In addition, the bipolar transistor 101 is grounded via a signal line L6. When the PI sensor 51 is outputting the OFF signal S3 via the signal line L5 (i.e., when the cover 34 is unlocked), the bipolar transistor 101 is turned on, so that the heater circuit 90 and the protection circuit 100 become electrically connected to each other. Thus, the protection circuit 100 connects the signal line L3 to the ground.

In contrast, when the PI sensor 51 is outputting the ON signal S4 via the signal line L5 (i.e., when the cover 34 is locked), the bipolar transistor 101 is turned off, so that the heater circuit 90 and the protection circuit 100 become electrically disconnected from each other. In this case, the controller 80 can input the High signal S1 or LOW signal S2 to the FET 94, via the signal line L3.

### [Operation]

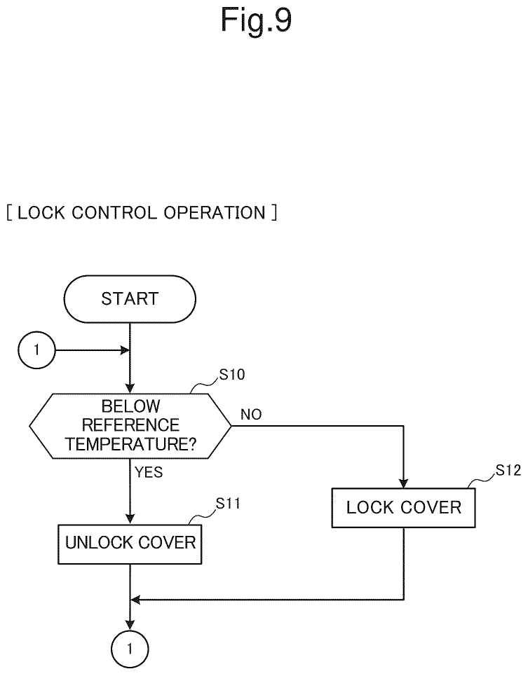

Referring now to FIG. 9 to FIG. 11, sheet jam an operation of the image forming system 1, performed when sheet jam has occurred, will be described hereunder.

For the following description, it will be assumed that, when the power to the drying device 3 is turned on, the controller 80 outputs the LOW signal S2 to the FET 94 via the signal line L3, thereby turning off the heaters 68, and that the cover 34 is unlocked, and the controller 80 has not activated the PI sensor 51. In this case, the heater circuit 90 and the protection circuit 100 are electrically disconnected from each other.

Upon receipt of image data and an instruction to execute a print job, under the mentioned situation, from the PC 22A via the communication device 22, the controller 19 of the image forming apparatus 2 activates the image forming device 12, the conveying device 13, the sheet feeding device 14, and the transport mechanism 15, thereby executing the printing operation to form the image represented by the image data received, on the sheet P. The controller 19 also transmits an instruction to start the drying operation to the drying device 3, via the I/F 21.

Upon receipt of the instruction to start the drying operation via the I/F 84, the controller 80 of the drying device 3 activates the first drive motor to rotate the drive roller 64A counterclockwise in FIG. 7, thereby causing the conveying belt 63 and the follower roller 64B to rotate counterclockwise in FIG. 7.

The controller 80 also switches the signal to be outputted to the FET 94b via the signal line L3 from the Low signal S2 to the High signal S1, thereby turning on the heaters 68, and activates the suction fans 66 to start blowing air. Accordingly, the execution of the drying operation, for heating and drying the ink on the sheet P being transported by the conveying device 61, is started.

After turning on the heaters 68, the controller 80 starts to execute a lock control operation specified in FIG. 9, and decides whether the temperature detected by the temperature sensor 70 is lower than a predetermined reference temperature (step S10). Although the reference temperature is not specifically limited, in this embodiment the reference temperature is set to 50 degrees Celsius.

The controller 80 continues to decide that the temperature detected by the temperature sensor 70 is below the reference temperature (YES at step S10), until the detected temperature reaches the reference temperature, and keeps the actuator 43 turned on to maintain the lever 42 in the unlocking posture shown in FIG. 4, thereby maintaining the cover 34 in the unlocked state (step S11).

When the temperature detected by the temperature sensor 70 reaches the reference temperature, with the heat from the heaters 68, the controller 80 decides that the detected temperature is not below the reference temperature (NO at step S10), and disconnects the power supply to the actuator 43, to cause the lever 42 to rotate so as to assume the locking posture shown in FIG. 5, thereby setting the cover 34 to the locked state (step S12). After step S11 or step S12, the controller 80 returns to step S10.

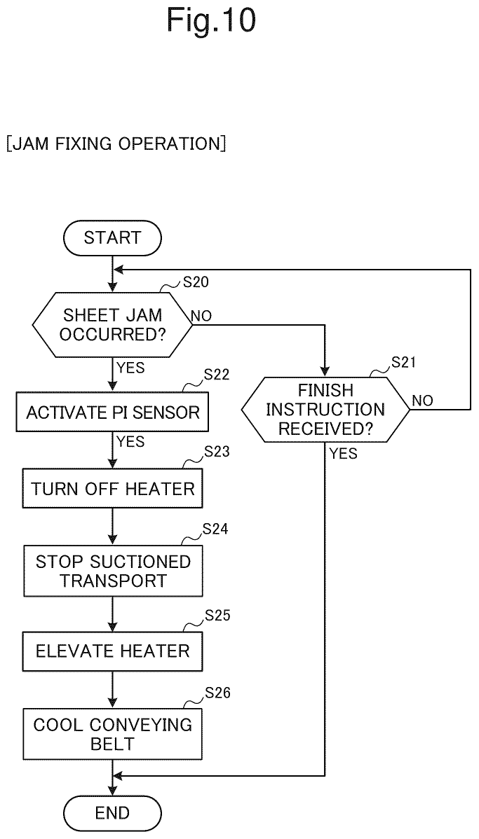

Upon starting the drying operation, the controller 80 also starts to execute a jam fixing operation specified in FIG. 10. The controller 80 either detects the occurrence of the sheet jam according to the detection result from a sheet sensor, for example provided in the proximity of the conveying belt 63, or repeatedly decides that the sheet jam has not occurred (NO at step S20), and that an instruction to finish the drying operation has not been received (NO at step S21), until receiving the instruction to finish the drying operation.

Upon receipt, via the I/F 84, of the instruction to finish the drying operation, transmitted from the image forming apparatus 2 that has finished the printing operation (YES at step S21), without detecting the occurrence of the sheet jam, the controller 80 finishes the sheet jam fixing operation and turns off the heaters 68, and also stops the operation of the first drive motor and the suction fan 66, thereby finishing the drying operation. Further, the controller 80 finishes the lock control operation.

On the other hand, for example when the sheet sensor does not output the absence of the sheet P, within a predetermined time after detecting the presence of the sheet P, the controller 80 decides that the sheet jam has occurred (YES at step S20), and activates the PI sensor 51 (step S22).

Since the lever 42 is in the locking posture at this point, the PI sensor 51 outputs the ON signal S4 via the signal line L5. Accordingly, the bipolar transistor 101 is turned off, and the heater circuit 90 and the protection circuit 100 remain electrically disconnected from each other.

After step S22, the controller 80 switches the signal to be outputted to the FET 94 via the signal line L3, from the High signal S1 to the Low signal S2, thereby turning off the heaters 54 (step S23).

After step S23, the controller 80 stops the operation of the first drive motor of the drive device 83 and the suction fan 66, thereby stopping the suctioned transport of the sheet P (step S24). After step S24, the controller 80 activates the second drive motor of the drive device 83 to cause the elevation mechanism to elevate the heating device 62, thereby moving the heating device 62 from the normal position, to a retracted position spaced from the conveying device 61 (step 25).

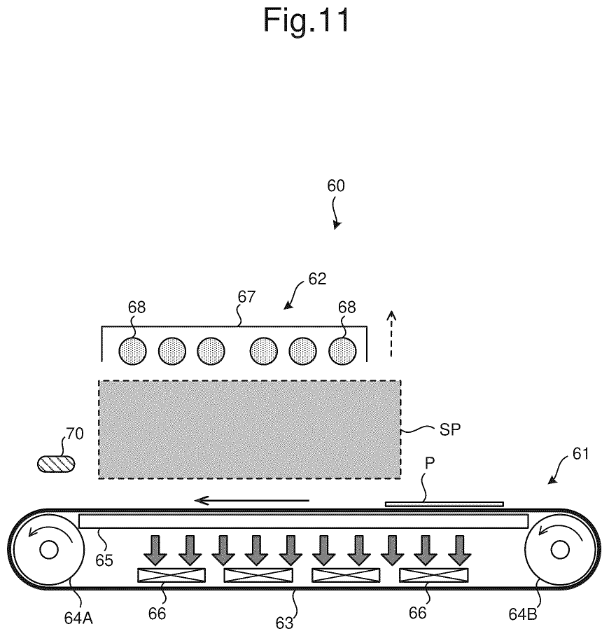

As result, a space SP, which allows the user to insert the hand and remove the sheet P, is defined between the conveying device 61 and the heating device 62, as shown in FIG. 11. After step S25, the controller 80 activates the cooling fans 36 to start blowing air, to thereby start to cool the conveying belt 63 (step 26). After step 26, the controller 80 finishes the sheet jam fixing operation.

By turning off the heaters 68 and activating the cooling fans 36, the internal space of the casing 30 is cooled. When the temperature detected by the temperature sensor 70 becomes below the reference temperature (YES at step S10), the controller 80 supplies the power to the actuator 43 to rotate the lever 42 to the unlocking position shown in FIG. 4, thereby setting the cover 34 to the unlocked state (step S11).

When the lever 42 assumes the unlocking posture, the PI sensor 51 outputs the OFF signal S3 via the signal line L5. Accordingly, the bipolar transistor 101 is turned on, to electrically connect the heater circuit 90 and the protection circuit 100. As result, the signal line L3 is grounded.

Here, it will be assumed that the processor of the control device 81 has malfunctioned under the mentioned situation, and the controller 80 has erroneously switched the signal to be outputted to the FET 94 via the signal line L3 from the Low signal S2 to the High signal S1. In this case, however, since the signal line L3 is grounded, the High signal S1 is not inputted to the FET 94, and the heaters 68 are not turned on.

Therefore, even when the controller 80 outputs the High signal S1 owing to a malfunction, the user can open the cover, insert the hand into the space SP, and remove the sheet P, with the heaters 68 kept turned off.

When the sheet sensor outputs the absence of the sheet P, because of the sheet P having been removed (i.e., when the sheet jam is fixed), the controller 80 activates the second drive motor of the drive device 83, to cause the elevation mechanism to move the heating device 62 downward, from the retracted position to the normal position. The controller 80 also stops the operation of the cooling fans 36. Further, the controller 80 finishes the lock control operation.

According to the mentioned embodiment, the drying device 3 includes the casing 30 including the cover 34 that can be opened and closed, the lock mechanism 40 that restricts the cover 34 from being opened, the detection device 50 that detects the unlocking action of the lock mechanism 40, the heaters 68 provided inside the casing 30, and configured to raise the temperature when power is supplied, the controller 80 that controls the power supply to the heaters 68, and the action of the lock mechanism 40, and the protection circuit 100 that disconnects the power supply to the heaters 68, when the detection device 50 detects the unlocking action.

With the mentioned configuration, the power supply to the heaters 68 is forcibly disconnected, when the cover 34 is unlocked, and therefore a temperature increase of the heaters 68 due to the malfunction of the controller 80 can be prevented. As result, the heaters 68 can be surely turned off, when the user makes access to the internal space of the casing 30.

According to the foregoing embodiment, the detection device 50 detects the unlocking action, by detecting the position of the moving element 46. Such an arrangement further ensures that the unlocking action is detected, compared with the case of monitoring the power supply control by the controller 80 with respect to the lock mechanism 40.

According to the foregoing embodiment, the controller 80 controls the power supply to the heaters 68 via the signal line L3, and the protection circuit 100 disconnects the power supply to the heaters 68, by connecting the signal line L3 to the ground. Therefore, the disconnection of the power supply to the heaters 68 can be further ensured.

According to the foregoing embodiment, in addition, the controller 80 causes the lock mechanism 40 to lock the cover 34, when the temperature detected by the temperature sensor 70 exceeds the predetermined reference temperature, and causes the lock mechanism 40 to unlock the cover 34, when the temperature detected by the temperature sensor 70 is below the reference temperature. Such an arrangement further assures that the power supply to the heaters 68 is disconnected, when the user makes access to the internal space of the casing 30.

According to the foregoing embodiment, further, the conveying device 61 transports the sheet P, and the heaters 68 heat the sheet P being transported by the conveying device 61, in the drying device 3. Therefore, the power supply to the heaters 68 can be surely disconnected, when the user opens the cover 34 and makes access to the proximity of the heaters 68 to remove the sheet, in the event of the sheet jam.

According to the foregoing embodiment, further, the image forming system 1 includes the image forming apparatus 2 and the drying device 3. Therefore, the image forming operation with the ink can be performed, under a high security level.

### Other Variation

Although the bipolar transistor 101 is of the NPN type in the foregoing embodiment, the disclosure is not limited to such embodiment. For example, the bipolar transistor 101 may be of a PNP type.

Normally, when the power to the apparatus is turned on, the heating device is kept from increasing the temperature, when the user inserts the hand to the internal space of the casing to fix the sheet jam, provided that the processor controlling the power supply to the heating device is properly operating. However, when the processor malfunctions, for example owing to thermal runaway, and erroneously increases the temperature of the heating device, the temperature inside the casing is excessively increased.

In contrast, with the configuration according to the foregoing embodiment, the temperature increase of the heating device due to the malfunction of the controller can be prevented, and therefore the excessive temperature increase inside the drying device can be surely prevented.

Further, the configurations and processings described in the embodiments with reference to FIG. 1 to FIG. 11 are merely exemplary, and in no way intended to limit the disclosure to those configurations and processings.

While the present disclosure has been described in detail with reference to the embodiments thereof, it would be apparent to those skilled in the art that the various changes and modifications may be made therein within the scope defined by the appended claims.

What is claimed is:

1. A drying device comprising:
a casing including a cover that can be opened and closed;
a lock mechanism that restricts the cover from being opened;
a heating device provided inside the casing, and configured to raise a temperature when power is supplied;
a control device including a processor, and configured to act, when the processor executes a control program, as a controller that controls power supply to the heating device, and an action of the lock mechanism;
a detection device that detects an unlocking action of the lock mechanism; and
a disconnection mechanism that disconnects the power supply to the heating device, when the detection device detects the unlocking action.

2. The drying device according to claim 1,
wherein the cover opens up an opening formed in the casing, in an opened state, and closes the opening in a closed state, and
the heating device includes heaters provided inside the casing.

3. The drying device according to claim 1,
wherein the lock mechanism includes a moving element that changes a position between when keeping the cover locked and when keeping the cover unlocked, and
the detection device detects the unlocking action, by detecting the position of the moving element.

4. The drying device according to claim 1,
wherein the controller controls the power supply to the heating device via a signal line, and
the disconnection mechanism disconnects the power supply to the heating device, by connecting the signal line to ground.

5. The drying device according to claim 1, further comprising a temperature sensor that detects a temperature inside the casing,
wherein the controller is configured to:
cause the lock mechanism to lock the cover, when a temperature detected by the temperature sensor exceeds a predetermined reference temperature; and
cause the lock mechanism to unlock the cover, when the temperature detected by the temperature sensor is below the reference temperature.

6. The drying device according to claim 1, further comprising a conveying device provided inside the casing to convey a sheet,
wherein the heating device heats the sheet being conveyed by the conveying device.

7. An image forming system comprising:
an image forming apparatus that forms an image on a sheet, by ejecting ink thereon; and
the drying device according to claim 1.
